(19) United States
(12) Patent Application Publication
(10) Pub. No.: US 2026/0362331 A1
(43) Pub. Date: Nov. 12, 2026

(54) MODE CHANGE OF LP-WUS UE

(71) Applicant: Nokia Technologies Oy, Espoo (FI)

(72) Inventors: Amaanat ALI, Espoo (FI); Palihawadana Arachchige Dinu Nirmal JAYAWARDANA, Espoo (FI); Jussi-Pekka KOSKINEN, Oulu (FI); Jorma Johannes KAIKKONEN, Oulu (FI); Jani-Pekka KAINULAINEN, Cambridge (GB)

(21) Appl. No.: 19/203,431

(22) Filed: May 9, 2025

(51) Int. Cl. H04W 52/02; H04W 36/00; H04W 52/36

(52) U.S. Cl. CPC H04W 52/0235; H04W 36/0085; H04W 52/367

(57) ABSTRACT

Embodiments of the present disclosure relate to mode change for a low power (LP) wake up signal (LP-WUS) capable user equipment (UE). In an aspect, a first apparatus receives configuration information from a second apparatus. The configuration information indicates at least one condition for monitoring and measurement modes for a LP-WUS UE. The at least one condition is associated with one or more time parameters. The first apparatus determines to change a mode based on determining at least one of (i) the at least one condition or (ii) at least one criterion of the first apparatus is satisfied.

### FIELD

Various example embodiments relate to the field of communication and in particular, to apparatuses, methods, and a computer readable medium for mode change of a low power (LP) wake up signal (LP-WUS) user equipment (UE).

### BACKGROUND

A communication network can be seen as a facility that enables communications between two or more communication devices, or provides communication devices access to a data network. A mobile or wireless communication network is one example of a communication network.

Such communication networks operate in accordance with standards, such as those promulgated by Third Generation Partnership Project (3GPP) or European Telecommunications Standards Institute (ETSI). Examples of such standards include the so-called 5th generation (5G) standard, 6th generation (6G) or other standards promulgated by 3GPP.

### SUMMARY

In general, example embodiments of the present disclosure provide a solution for mode change of a low power (LP) wake up signal (LP-WUS) user equipment (UE).

In a first aspect, there is provided a first apparatus. The first apparatus comprises at least one processor; and at least one memory storing instructions that, when executed by the at least one processor, cause the first apparatus at least to: receive, from a second apparatus, configuration information indicating at least one condition for monitoring and/or measurement modes for a low power (LP) wake up signal (LP-WUS) capable user equipment (UE), wherein the at least one condition is associated with one or more time parameters, and determine whether to change a mode based on the at least one condition.

In a second aspect, there is provided a second apparatus. The second apparatus comprises at least one processor; and at least one memory storing instructions that, when executed by the at least one processor, cause the second apparatus at least to: determine, for a low power (LP) wake up signal (LP-WUS) capable user equipment (UE), configuration information indicating at least one condition for monitoring and/or measurement modes, wherein the at least one condition is associated with one or more time parameters, and transmit the configuration information.

In a third aspect, there is provided a first apparatus. The first apparatus comprises at least one processor; and at least one memory storing instructions that, when executed by the at least one processor, cause the first apparatus at least to: receive, from a second apparatus, configuration information indicating at least one condition for monitoring and measurement modes for a low power (LP) wake up signal (LP-WUS) capable user equipment (UE), wherein the at least one condition is associated with one or more time parameters, and determine to change a mode based on determining at least one of (i) the at least one condition or (ii) at least one criterion of the first apparatus is satisfied.

In a fourth aspect, there is provided a method. The method comprises receiving, at a first apparatus and from a second apparatus, configuration information indicating at least one condition for monitoring and/or measurement modes for a low power (LP) wake up signal (LP-WUS) capable user equipment (UE), wherein the at least one condition is associated with one or more time parameters, and determining whether to change a mode based on the at least one condition.

In a fifth aspect, there is provided a method. The method comprises determining, at a second apparatus and for a low power (LP) wake up signal (LP-WUS) capable user equipment (UE), configuration information indicating at least one condition for monitoring and/or measurement modes, wherein the at least one condition is associated with one or more time parameters, and transmitting the configuration information.

In a sixth aspect, there is provided a method. The method comprises receiving, at a first apparatus and from a second apparatus, configuration information indicating at least one condition for monitoring and measurement modes for a low power (LP) wake up signal (LP-WUS) capable user equipment (UE), wherein the at least one condition is associated with one or more time parameters, and determining to change a mode based on determining at least one of (i) the at least one condition or (ii) at least one criterion of the first apparatus is satisfied.

In a seventh aspect, there is provided an apparatus. The apparatus comprises means for receiving, at a first apparatus and from a second apparatus, configuration information indicating at least one condition for monitoring and/or measurement modes for a low power (LP) wake up signal (LP-WUS) capable user equipment (UE), wherein the at least one condition is associated with one or more time parameters, and means for determining whether to change a mode based on the at least one condition.

In an eighth aspect, there is provided an apparatus. The apparatus comprises means for determining, at a second apparatus and for a low power (LP) wake up signal (LP-WUS) capable user equipment (UE), configuration information indicating at least one condition for monitoring and/or measurement modes, wherein the at least one condition is associated with one or more time parameters, and means for transmitting the configuration information.

In a ninth aspect, there is provided an apparatus. The apparatus comprises means for receiving, at a first apparatus and from a second apparatus, configuration information indicating at least one condition for monitoring and measurement modes for a low power (LP) wake up signal (LP-WUS) capable user equipment (UE), wherein the at least one condition is associated with one or more time parameters, and means for determining to change a mode based on determining at least one of (i) the at least one condition or (ii) at least one criterion of the first apparatus is satisfied.

In a tenth aspect, there is provided a first apparatus. The first apparatus comprises receiving circuitry configured to receive, from a second apparatus, configuration information indicating at least one condition for monitoring and/or measurement modes for a low power (LP) wake up signal (LP-WUS) capable user equipment (UE), wherein the at least one condition is associated with one or more time parameters, and determining circuitry configured to determine whether to change a mode based on the at least one condition.

In an eleventh aspect, there is provided a second apparatus. The second apparatus comprises determining circuitry configured to determine, for a low power (LP) wake up signal (LP-WUS) capable user equipment (UE), configuration information indicating at least one condition for monitoring and/or measurement modes, wherein the at least one condition is associated with one or more time parameters, and transmitting circuitry configured to transmit the configuration information.

In a twelfth aspect, there is provided a first apparatus. The first apparatus comprises receiving circuitry configured to receive, from a second apparatus, configuration information indicating at least one condition for monitoring and measurement modes for a low power (LP) wake up signal (LP-WUS) capable user equipment (UE), wherein the at least one condition is associated with one or more time parameters, and determining circuitry configured to determine to change a mode based on determining at least one of (i) the at least one condition or (ii) at least one criterion of the first apparatus is satisfied.

In a thirteenth aspect, there is provided a non-transitory computer readable medium comprising program instructions for causing an apparatus to perform at least the method according to any one of the above fourth to sixth aspect.

In a fourteenth aspect, there is provided a computer program comprising instructions, which, when executed by an apparatus, cause the apparatus to perform at least the method according to any one of the above fourth to sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication network in which embodiments of the present disclosure may be implemented;

FIG. 1B illustrates UE operations with low power (LP) wake-up receiver (WUR) associated with some embodiments of the present disclosure;

FIG. 2 illustrates a flowchart illustrating a process for mode change for a LP-WUS UE according to some embodiments of the present disclosure;

FIG. 3 illustrates an example process of proposed solution according to some embodiments of the present disclosure;

FIG. 4 illustrates a flowchart illustrating a process for mode change for a LP-WUS UE according to some embodiments of the present disclosure;

FIG. 5 illustrates an example process according to some embodiments of the present disclosure;

FIG. 6 illustrates a flowchart of a method implemented at a first apparatus according to some embodiments of the present disclosure;

FIG. 7 illustrates a flowchart of a method implemented at a second apparatus according to some embodiments of the present disclosure;

FIG. 8 illustrates a flowchart of a method implemented at a first apparatus according to some embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. As used herein, the terms “the at least one” and “the one or more” mean “any one of the at least one” and “any one of the one or more”, respectively.

As used in this application, the term “circuitry” may refer to one or more or all of the following:
(a) hardware-only circuit implementations (such as implementations in analog, digital and/or quantum circuitry) and
(b) combinations of hardware circuit(s) and software, such as (as applicable):
   (i) a combination of analog, digital and/or quantum hardware circuit(s) with software/firmware and
   (ii) any or all portions of hardware processor(s) (including digital and/or quantum processor(s)) with software, and memory(ies) that work together to cause an apparatus, such as a mobile device, computing device, or server, to perform various functions) and
(c) any or all portions of hardware circuit(s), such as a microprocessor(s), processor(s) and/or quantum processor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The terms “time period” and “time interval” are related but have different meanings, depending on the context. The term “time period” refers to a span or duration of time, often associated with cycles or recurring events. It usually has a defined start and end, but it often emphasizes the overall duration rather than specific moments within it. For example, the oscillation of a pendulum has a period of 2 seconds (meaning it completes one full cycle every 2 seconds).

The term “time interval” refers to the measurable gap or difference between two specific points in time. It focuses more on the distance between moments rather than an ongoing cycle. For example, the time interval between two heartbeats is 0.8 seconds. The time interval between two meetings was 30 minutes.

The key difference between the time period and the time interval is that a time period often implies a duration with a certain characteristic (e.g., a historical era, a recurring cycle), while a time interval is the time gap between two specific points.

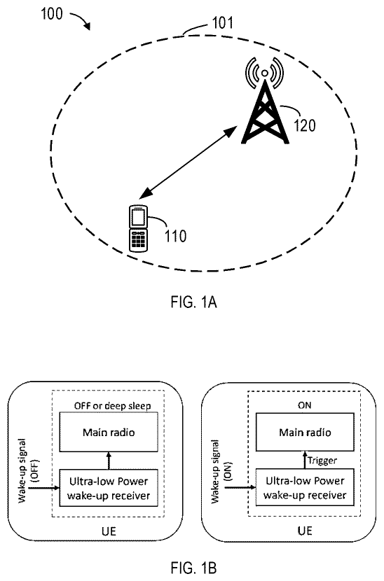

FIG. 1A illustrates an example network environment 100 in which example embodiments of the present disclosure may be implemented. The environment 100A, which may be a part of a communication network, comprises terminal devices and network devices.

As illustrated in FIG. 1A, the communication network 100A may comprise a first apparatus 110 (hereinafter may also be referred to as user equipment 110 or a terminal device 110), and a second apparatus 120 (hereinafter may also be referred to as network device 120 or base station 120). The second apparatus 120 can manage a cell 101. The first apparatus 110 and the second apparatus 120 can communicate with each other in the coverage of the cell 101. A communication link from the first apparatus 110 to the second apparatus 120 is referred to as an uplink (UL), while a communication link from the second apparatus 120 to the first apparatus 110 is referred to as a downlink (DL).

It is to be understood that the number of devices is only for the purpose of illustration without suggesting any limitations. The system 100A may include any suitable number of terminal devices or network devices adapted for implementing embodiments of the present disclosure. Although not shown, it would be appreciated that one or more terminal devices or network devices may be located in the environment 100A.

Communications in the communication system 100A may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: code division multiple access (CDMA), frequency division multiple access (FDMA), time division multiple access (TDMA), frequency division duplex (FDD), time division duplex (TDD), multiple-input multiple-output (MIMO), orthogonal frequency division multiple (OFDM), discrete Fourier transform spread OFDM (DFT-s-OFDM) and/or any other technologies currently known or to be developed in the future.

With the development of communication technology, the use of a low-power wake-up receiver (LR) at the UE is enabled instead of the main receiver (MR), so that the UE may reduce power consumption. The MR of a UE is enabled to enter the sleep mode or be powered off for power saving and be activated only upon receiving a WUS from the network. The network triggers the UE to wake up in an event-driven manner by transmitting the WUS, which is monitored by the LR at the UE. Upon receiving the WUS, the LR triggers the MR transceiver to wake up and start communication using the MR, as shown in FIG. 1B. The ultra-low power receiver or LR remains always on with minimal power consumption, significantly less than the MR transceiver, by using a simple WUS signal and specialized hardware for monitoring.

Furthermore, it has been considered that serving cell evaluations may be offloaded from the MR to the LR to enable the large power saving. The LR may carry the serving cell evaluation related measurements based on a new reference signal, a low power synchronization signal (LP-SS), or synchronization signal block (SSB) depending on the LR type. With LR in operation, the UE may change from the normal operational mode where the LP-WUS is not used/monitored to the LP-WUS monitoring mode, to the radio resource management (RRM) measurement relaxation mode with LP-WUR based measurements, or to the serving cell measurement offloading to the LP-WUR mode.

The UE may change between the normal mode (LP-WUS is not used/monitored), LP-WUS monitoring, RRM measurement relaxation, and RRM offloading to LP-WUR modes frequently based on the entry/exit conditions. The entry/exit conditions are related to the event triggers which may result in ping-ping effects when switching between modes or states. This frequent switching may be inefficient from the perspective of the LP-WUS/paging monitoring and mobility. Therefore, the switching across different modes of LP-WUS scenarios is to be optimized.

According to embodiments of the present disclosure, there is provided a solution for mode change for a LP-WUS UE. In one aspect of this solution, a first apparatus receives configuration information from a second apparatus. The configuration information indicates at least one condition for monitoring and/or measurement modes for a low power (LP) wake up signal (LP-WUS) capable user equipment (UE). The at least one condition is associated with one or more time parameters. The first apparatus determines whether to change a mode based on the at least one condition.

In another aspect of this solution, a first apparatus receives configuration information from a second apparatus. The configuration information indicates at least one condition for monitoring and measurement modes for a low power wake up signal (LP-WUS) capable user equipment (UE). The at least one condition is associated with one or more time parameters. The first apparatus determines to change a mode based on determining at least one of (i) the at least one condition or (ii) at least one criterion of the first apparatus is satisfied.

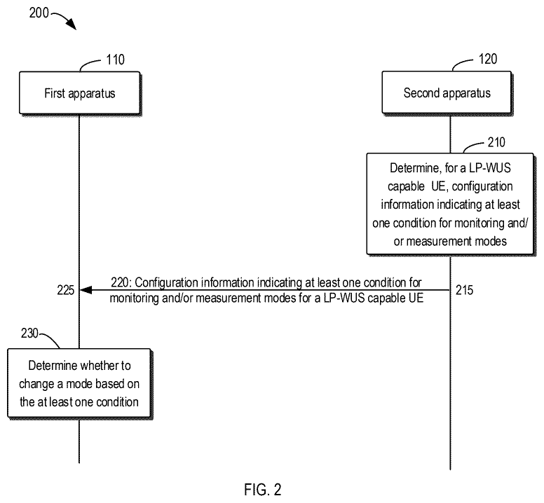

In this way, the first apparatus does not need to switch between different modes too frequently. Therefore, the communication efficiency is improved. Principles and implementations of embodiments of the present disclosure will be described in detail below with reference to FIGS. 2-10.

Reference is now made to FIG. 2, which shows a process 200 for mode change for a LP-WUS UE according to an embodiment of the present disclosure. For the purpose of discussion, the process 200 will be described with reference to FIG. 1A. The process 200 may involve the first apparatus 110 and the second apparatus 120 as illustrated in FIG. 1A. In some embodiments, the first apparatus may be a UE or comprised in a UE, and the second apparatus may be a network device. It would be appreciated that although the process 200 has been described in the communication system 100 of FIG. 1A, this process may be likewise applied to other communication scenarios

In the process 200, the second apparatus 120 determines 210, for a LP-WUS capable UE, configuration information indicating at least one condition for monitoring and/or measurement modes. The at least one condition is associated with one or more time parameters.

In some embodiments, the monitoring and measurement modes may comprise a normal mode without using or monitoring LP-WUS, a LP-WUS monitoring mode, a relaxed measurement mode, a serving cell measurement offloading to a LP wake up receiver (LR) mode, or any combination of above two or more of the above-mentioned items.

The one or more time parameters may comprise a time period/instance or time interval. In some embodiments, the one or more time parameters may comprise a first time period indicating a minimum period between a first entry into a mode and a second entry into the same mode, a second time period indicating a minimum period between a first exit from a mode and a second exit from the same mode, a time interval indicating a minimum interval between an entry into a first mode and an entry into a second mode, or any combination of above two or more of the above-mentioned items. It is to be understood that the time period may equal a time interval in some cases.

In some embodiments, the time period may be associated with an entry condition of the at least one condition. In other words, the time period may be used for entry conditions only since the exit may happen faster. Alternatively or additionally, the time period may be associated with an exit condition of the at least one condition. In addition, the time period may be associated with an entry condition and an exit condition of the at least one condition, i.e., the time period may be used for both entry and exit conditions.

In an example, a timer may be implemented for an entry condition and mode change only. Similarly, an exit condition timer may also be implemented. The example is just an enabling example and not limiting any other implementation. Any combination of the “time period” or “time interval” or different conditions should not be excluded.

Additionally, the one or more time parameters may be predefined and/or received from the second apparatus 120. In an example, the time period may be statically specified in the specifications of a standard document of e.g., 3GPP. In another example, the network (i.e., the second apparatus 120) may configure the time period with broadcast and/or dedicated signaling.

In some embodiments, the second apparatus 120 may transmit the one or more time parameters to the first apparatus 110. Additionally, the one or more time parameters may be transmitted via a system information (block) or a dedicated radio resource control (RRC) message, or a combination of above two items.

For example, the timer values for entry conditions and/or exit condition may be configured by the network to the UE using system information block 1 (SIB1), a specific system information block (SIBn) (e.g., broadcast used in RRC idle and RRC inactive mode), an RRC reconfiguration (e.g., RRC connected) message or an RRC release message.

In addition, the at least one condition may comprise multiple conditions, a time parameter of the one or more time parameters may be used for the multiple conditions. For example, the same time period may be used for all the conditions. Additionally, a time parameter of the one or more time parameters may be used for a condition of the multiple conditions. For example, each condition may have individual time period.

Continuing with reference to FIG. 2, the second apparatus 120 transmits 215 the configuration information 220 to the first apparatus 110. In some embodiments, the configuration information 220 may transmit the configuration information 220 to multiple apparatuses comprising the first apparatus 110 by broadcast. In some alternative embodiments, the configuration information 220 may transmit the configuration information 220 to the first apparatus 110 by a dedicated signaling. For example, the configuration information may be received via a system information block, an RRC message, or a combination of above two items.

Continuing with reference to FIG. 2, after receiving 225 the configuration information 220, the first apparatus 110 determines 230 whether to change a mode based on the at least one condition.

In some embodiments, the at least one condition may indicate that the one or more time parameters associated with the at least one condition have elapsed. If the one or more time parameters does not elapse, the first apparatus 110 may determine not to change the mode. If the one or more time parameters have elapsed, the first apparatus 110 may determine to change the mode.

In general, a set of time parameters (e.g., time period/instances, or time interval) is introduced during one or more of the following conditions (“LP-WUS monitoring (7.x.1)”, “Serving cell measurement offloading criterion for LP-WUS UE (section 5.2.4.9.z)”, “Relaxed measurement criterion for LP-WUS UE (section 5.2.4.9.x)”) need to be fulfilled. An example of introducing the set of time parameters to each of the sections mentioned above is provided.

### 5.2.4.9.x Relaxed Measurement Criterion for LP-WUS UE

The entry condition for serving cell measurement relaxation is fulfilled when:
Srxlev>SLP_WUS_RelaxEntryThresholdP_MR, and,
Srxlev_lr>SLP_WUS_RelaxEntryThresholdP_LR, if SLP_WUS_RelaxEntryThresholdP_LR is configured, and,
Squal>SLP_WUS_RelaxEntryThresholdQ_MR, if SLP_WUS_RelaxEntryThresholdQ_MR is configured, and
Squal_lr>SLP_WUS_RelaxEntryThresholdQ_LR, if SLP_WUS_RelaxEntryThresholdQ_LR is configured and,
a time interval TLP_WUS_RelaxEntry has elapsed, if TLP_WUS_RelaxEntry is configured and,
a duration of time TLP_WUS_Mode_Change has elapsed, if TLP_WUS_Mode_Change is configured

Where:
Srxlev=current Srxlev value of the serving cell (dB).
Squal=current Squal value of the serving cell (dB).
Srxlev_lr=current measured cell RX level value of the serving cell based on LR (dB).
Squal_lr 32 current measured cell quality value of the serving cell based on LR (dB).

### 5.2.4.9.y Serving Cell Offloading Measurement Rules

LP-WUS UE may choose to perform serving cell measurement offloading (i.e., serving cell measurement fully offloaded to LR and no serving cell measurement via MR is required) according to requirements specified in TS 38.133 [8] if the entry condition for serving cell measurement offloading in clause 5.2.4.9.z is fulfilled. LP-WUS UE is not required to perform serving cell measurement offloading according to requirements specified in TS 38.133 [8] if the exit condition for serving cell measurement offloading in clause 5.2.4.9.z is fulfilled.

### 5.2.4.9.z Serving Cell Measurement Offloading Criterion for LP-WUS UE

The entry condition for serving cell measurement offloading is fulfilled when:
Srxlev>SLP_WUS_offloadingEntryThresholdP_MR, and,
Srxlev_lr>SLP_WUS_offloadingEntryThresholdP_LR, if SLP_WUS_offloadingxEntryThresholdP_LR is configured and,
a time interval TLP_WUS_offloadingEntry has elapsed, if TLP_WUS_offloadingEntry is configured and,
   a duration of time TLP_WUS_Mode_Change has elapsed, if TLP_WUS_Mode_Change is configured

Where:
Srxlev=current Srxlev value of the serving cell (dB).
Srxlev_lr=current measured cell RX level value of the serving cell based on LR (dB).

The exit condition for serving cell measurement offloading is fulfilled when:
Srxlev_lr<SLP_WUS_offloadingExitThresholdP_LR,

### Where:

Srxlev_lr=current measured cell RX level value of the serving cell based on LR (dB).

### 7.x.1 Condition for LP-WUS Monitoring

The entry condition for LP-WUS monitoring is fulfilled when:
Srxlev>SLP_WUS_EntryThresholdP_MR, and,
rxlev_lr>SLP_WUS_EntryThresholdP_LR, if SLP_WUS_EntryThresholdP_LR is configured, and,
Squal>SLP_WUS_EntryThresholdQ_MR, if SLP_WUS_EntryThresholdQ_MR is configured, and
Squal_lr>SLP_WUS_EntryThresholdQ_LR, if SLP_WUS_EntryThresholdQ_LR is configured and,
a time interval TLP_WUS_EntryThreshold has elapsed, if TLP_WUS_ EntryThreshold is configured and,
a duration of time TLP_WUS_Mode_Change has elapsed, if TLP_WUS_Mode_Change is configured

### Where:

Srxlev=current Srxlev value of the serving cell (dB).
Squal=current Squal value of the serving cell (dB).
Srxlev_lr=current measured cell RX level value of the serving cell based on LR (dB).
Squal_lr=current measured cell quality value of the serving cell based on LR (dB).

The exit condition for LP-WUS monitoring is fulfilled when:
Srxlev_lr<SLP_WUS_ExitThresholdP_LR, if SLP_WUS_ExitThresholdP_LR is configured, or,
Squal_lr<SLP_WUS_ExitThresholdQ_LP, if SLP_WUS_ExitThresholdQ_LR is configured,

### Where:

Srxlev_lr=current measured cell RX level value of the serving cell based on LR (dB).
Squal_lr=current measured cell quality value of the serving cell based on LR (dB).

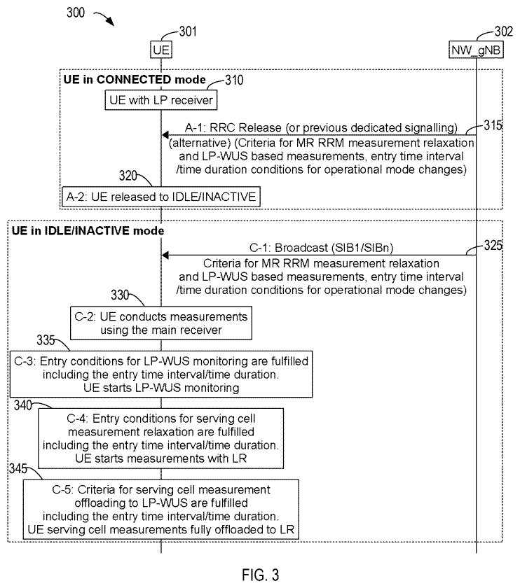

FIG. 3 illustrates an example process of proposed solution according to some embodiments of the present disclosure. The procedure 300 may involve a UE 301 and a NW_gNB 302. It is understood that the process 300 can be considered as a more specific example of the process 200 in FIG. 2. Thus, the UE 301 in FIG. 3 may be an example of the first apparatus 110 in FIG. 2, and the NW_gNB 302 in FIG. 3 may be an example of the second apparatus 120 in FIG. 2.

In the scenario of procedure 300, the UE 301 uses the entry time interval or time duration conditions for operational mode changes for a LP-WUS capable UE. As shown in FIG. 3, the UE 301 may be in connected mode or idle/inactive mode. At 310, the UE 301 is in the connected mode, and the UE 301 is configured with the LP receiver, i.e., the UE 301 is a LP-WUS capable UE. At 315, the NW_gNB 302 transmits an RRC release message (or previous dedicated signalling) to the UE 301. Alternatively, the NW_gNB 302 may further transmit the criteria for the MR RRM measurement relaxation and LP-WUS based measurements, entry time interval/time duration conditions for operational mode changes at 315. At 320, the UE 301 releases to the idle/inactive mode.

At 325, the NW_gNB 302 transmits broadcasts (e.g., via SIB1/SIBn) criteria for MR RRM measurement relaxation and LP-WUS based measurements, entry time interval/time duration conditions for operational mode changes.

At 330, the UE 301 conducts measurements using the main receiver. At 335, based on determining that entry conditions for LP-WUS monitoring including the entry time interval/time duration are fulfilled, the UE 301 starts LP-WUS monitoring. At 340, based on determining that entry conditions for serving cell measurement relaxation including the entry time interval/time duration are fulfilled, the UE 301 starts measurements with LR. At 345, based on determining that criteria for serving cell measurements offloading to LR including the entry time interval/time duration are fulfilled, the UE 301 serving cell measurements fully offloaded to LR.

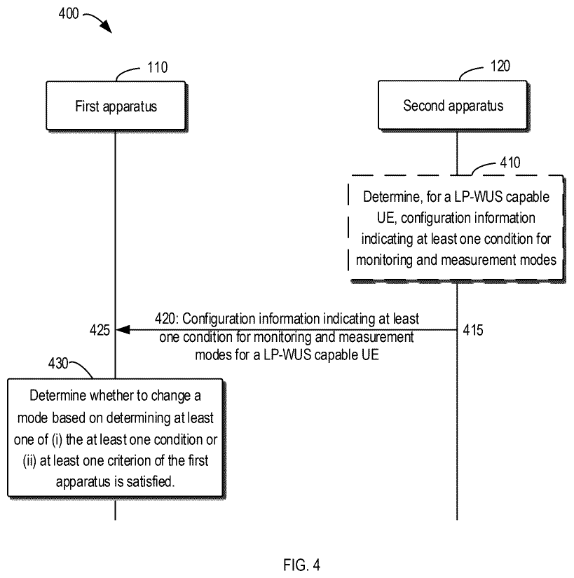

Reference is now made to FIG. 4, which shows a process 400 for mode change for a LP-WUS UE according to an embodiment of the present disclosure. For the purpose of discussion, the process 400 will be described with reference to FIG. 1A. The process 400 may involve the first apparatus 110 and the second apparatus 120 as illustrated in FIG. 1A. In some embodiments, the first apparatus 110 may be a UE or comprised in a UE, and the second apparatus 120 may be a network device. It would be appreciated that although the process 400 has been described in the communication system 100 of FIG. 1A, this process may be likewise applied to other communication scenarios.

In the process 400, the second apparatus 120 may determine 410, for a LP-WUS capable UE, configuration information indicating at least one condition for monitoring and/or measurement modes. The at least one condition is associated with one or more time parameters.

In some embodiments, the monitoring and measurement modes may comprise a normal mode without using or monitoring LP-WUS, a LP-WUS monitoring mode, a serving cell measurement offloading to a LP wake up receiver (LR) mode, a relaxed measurement mode, or any combination of above two or more of the above-mentioned items.

Alternatively or additionally, the one or more time parameters may comprise a first time period indicating a minimum period between a first entry into a mode and a second entry into the same mode, a second time period indicating a minimum period between a first exit from a mode and a second exit from the same mode, a time interval indicating a minimum interval between an entry into a first mode and an entry into a second mode, or any combination of above two or more of the above-mentioned items.

In some embodiments, the time period may be associated with an entry condition of the at least one condition. Alternatively or additionally, the time period may be associated with an exit condition of the at least one condition. In addition, the time period may be associated with an entry condition and an exit condition of the at least one condition.

In some embodiments, the one or more time parameters may be predefined and/or received from the second apparatus 120. Additionally, the one or more time parameters may be received via a system information (block) or a dedicated RRC message, or a combination of above two items.

In addition, the at least one condition may comprise multiple conditions, a time parameter of the one or more time parameters may be used for the multiple conditions. Additionally, a time parameter of the one or more time parameters may be used for a condition of the multiple conditions.

Continuing with reference to FIG. 4, the second apparatus 120 may transmit 415 the configuration information 420 to the first apparatus 110. After receiving 425 the configuration information 420, the first apparatus 110 determines 430 to change a mode based on determining at least one of (i) the at least one condition or (ii) at least one criterion of the first apparatus is satisfied.

In some embodiments, the at least one condition may indicate that the one or more time parameters associated with the at least one condition have elapsed. Additionally, the configuration information may be received via a system information block, an RRC message, or a combination of above two items.

If the at least one condition is not satisfied and at least one criterion of the first apparatus is satisfied, the first apparatus 110 may determine to change the mode. For instance, the UE (i.e., the first apparatus 110) may decide based on internal implementation algorithm decide on the usage of LP-WUS receiver for conducting serving cell measurements under following scenarios.

For the LP-WUS monitoring mode, if the one or more time parameters have not elapsed, the first apparatus 110 may determine that the at least one condition for entering the LP-WUS monitoring mode is not satisfied. If the first apparatus 110 enters an inactive mode or an idle mode, the first apparatus 110 receives a criterion for LP-WUS based measurements from the second apparatus 120, an entry threshold for the LP-WUS monitoring mode is satisfied, or any combination of above two or more of the above-mentioned items is satisfied, the first apparatus 110 may determine that the at least one criterion of the first apparatus 110 is satisfied. Then the first apparatus 110 may determine to change the mode by starting the LP-WUS monitoring mode in the event that the at least one condition for entering the LP-WUS monitoring mode is not satisfied.

In a first example, the UE may directly start the LP-WUS monitoring when the UE enters the inactive or idle mode before the entry conditions for the LP-WUS monitoring mode are fulfilled including the entry time interval/time duration.

In a second example, the UE may decide to start the LP-WUS monitoring whenever the criteria for LP-WUS based measurements are provided by NW to the UE even if the criteria for starting LP-WUS monitoring including the entry time interval/time duration are not satisfied.

In a third example, the UE may directly start the LP-WUS monitoring if entry thresholds for the LP-WUS monitoring mode are fulfilled even if the entry time interval/time duration is not reached.

For the relaxed measurement mode, if the one or more time parameters have not elapsed, the first apparatus 110 may determine that the at least one condition for entering the relaxed measurement mode is not satisfied. If the first apparatus 110 receives a criterion for LP-WUS based measurements from the second apparatus 120, at least one entry threshold for the relaxed measurement mode is fully satisfied or partially satisfied, or a combination of above two items is satisfied, the first apparatus 110 may determine that the at least one criterion of the first apparatus 110 is satisfied. Then the first apparatus 110 may determine to change the mode by starting the relaxed measurement mode in the event that the at least one condition for entering the relaxed measurement mode is not satisfied.

In a fourth example, the UE may decide to always use the LR for serving cell measurements whenever the criteria for LP-WUS based measurements are provided by NW to the UE even if the criteria for serving cell measurement relaxation including the entry time interval/time duration are not satisfied.

In a fifth example, the UE may decide to start measurements with the LR if the entry thresholds for serving cell measurement relaxation are fulfilled fully or partially even if the entry time interval/time duration is not reached.

For the serving cell measurement offloading to the LR, if the one or more time parameters have not elapsed, the first apparatus 110 may determine that the at least one condition for entering the serving cell measurement offloading to the LR is not satisfied. If a criterion for serving cell measurement relaxation is satisfied, at least one entry threshold for fully offloading serving cell measurement to LP-WUS is satisfied, the first apparatus consumes less energy compared to main radio (MR) based measurements and the first apparatus needs to conserve energy, or any combination of above two or more of the above-mentioned items is satisfied, the first apparatus 110 may determine that the at least one criterion of the first apparatus 110 is satisfied. Then the first apparatus 110 may determine to change the mode by starting the serving cell measurement offloading to the LR mode in the event that the at least one condition for entering the relaxed measurement mode is not satisfied.

In a sixth example, the UE may decide to fully offload serving cell measurements to the LR if criteria for serving cell measurement relaxation are fulfilled before the criteria for fully offloading serving cell measurement to LP-WUS including the entry time interval/time duration are fulfilled.

In a seventh example, the UE may decide to fully offload serving cell measurements to the LR if entry thresholds for fully offloading serving cell measurement to the LP-WUS are fulfilled even if the entry time interval/time duration is not reached.

In an eighth example, the UE may decide to fully offload serving cell measurements to the LR when it consumes less energy compared to MR based measurements specially when the UE is in need of conserving energy.

In general, the UE make the decision based on UE internal implementation in the scenarios mentioned above. Additionally, a combination of scenarios mentioned above could also occur based on UE implementation. The UE could decide, based on the UE implementation, to start LP-WUS monitoring before the relevant entry time interval/time duration for start LP-WUS monitoring is reached and/or start measurements with LR before the relevant entry time interval/time duration for starting measurements with LR is reached and/or fully offload serving cell measurements to LR before the relevant entry time interval/time duration for fully offload serving cell measurements to LR is reached, if the respective entry thresholds are satisfied.

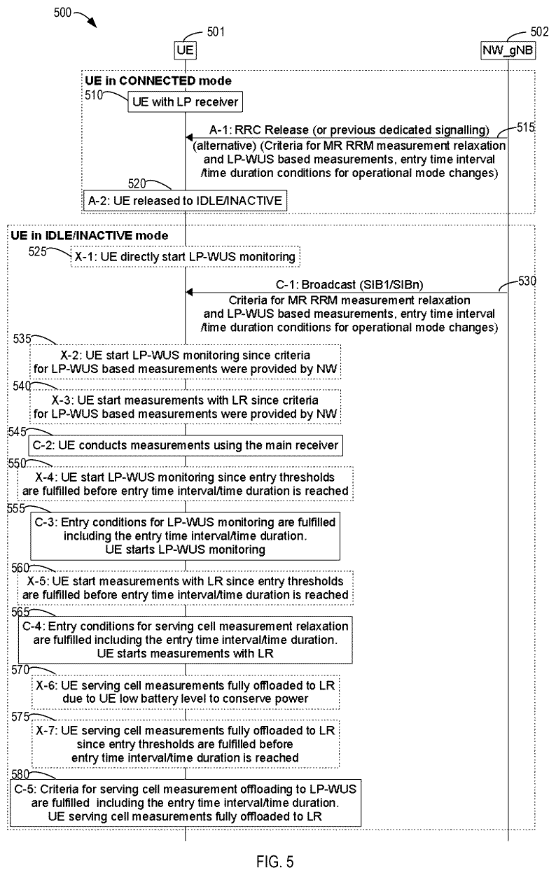

FIG. 5 illustrates an example process of proposed solution according to some embodiments of the present disclosure. The procedure 500 may involve a UE 501 and a NW_gNB 502. It is understood that the process 500 can be considered as a more specific example of the process 400 in FIG. 4. Thus, the UE 501 in FIG. 5 may be an example of the first apparatus 110 in FIG. 4, and the NW_gNB 502 in FIG. 5 may be an example of the second apparatus 120 in FIG. 4.

In the scenario of procedure 500, the UE 501 uses the entry time interval or time duration conditions or criteria based on UE internal implementation for operational mode changes for a LP-WUS capable UE. As shown in FIG. 5, the UE 501 may be in connected mode or idle/inactive mode. At 510, the UE 501 is in the connected mode, and the UE 501 is configured with the LP receiver, i.e., the UE 501 is a LP-WUS capable UE. At 515, the NW_gNB 502 transmits an RRC release message (or previous dedicated signalling) to the UE 501. Alternatively, the NW_gNB 502 may further transmit the criteria for the MR RRM measurement relaxation and LP-WUS based measurements, entry time interval/time duration conditions for operational mode changes at 515. At 520, the UE 501 releases to the idle/inactive mode.

At 525, the UE 501 may directly start LP-WUS monitoring when the UE 501 enters inactive or idle mode before the entry conditions for LP-WUS monitoring are fulfilled including the entry time interval/time duration.

At 530, the NW_gNB 502 transmits broadcasts (e.g., via SIB1/SIBn) criteria for MR RRM measurement relaxation and LP-WUS based measurements, entry time interval/time duration conditions for operational mode changes.

At 535, the UE 501 may start LP-WUS monitoring since criteria for LP-WUS based measurements were provided by NW even if the criteria for starting LP-WUS monitoring including the entry time interval/time duration are not satisfied.

At 540, the UE 501 may start measurements with LR since criteria for LP-WUS based measurements were provided by NW even if the criteria for serving cell measurement relaxation including the entry time interval/time duration are not satisfied.

At 545, the UE 501 conducts measurements using the main receiver. At 550, the UE 501 may start the LP-WUS monitoring since entry thresholds for LP-WUS monitoring are fulfilled even if the entry time interval/time duration is not reached.

At 555, based on determining that entry conditions for LP-WUS monitoring including the entry time interval/time duration are fulfilled, the UE 501 starts LP-WUS monitoring.

At 560, the UE 501 may start measurements with LR since entry thresholds for serving cell measurement relaxation are fulfilled even if the entry time interval/time duration is not reached.

At 565, based on determining that entry conditions for serving cell measurement relaxation including the entry time interval/time duration are fulfilled, the UE 501 starts measurements with LR.

At 570, the UE 501 may decide to fully offload serving cell measurements to LR due to UE low energy level to conserve power.

At 575, the UE 501 may decide to fully offload serving cell measurements to LR since entry thresholds for fully offloading serving cell measurement to LP-WUS are fulfilled even if entry time interval/time duration is not reached.

At 580, based on determining that criteria for serving cell measurements offloading to LR including the entry time interval/time duration are fulfilled, the UE 501 serving cell measurements fully offloaded to LR.

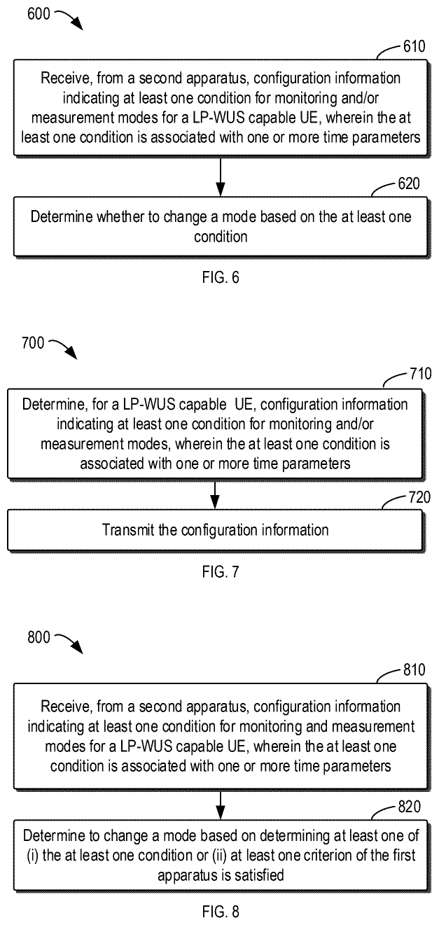

FIG. 6 shows a flowchart of an example method 600 implemented at a first apparatus in accordance with some embodiments of the present disclosure. For the purpose of discussion, the method 600 will be described from the perspective of the first apparatus 110 with reference to FIG. 1A.

At block 610, the first apparatus 110 receives, from a second apparatus, configuration information indicating at least one condition for monitoring and/or measurement modes for a low power (LP) wake up signal (LP-WUS) capable user equipment (UE), wherein the at least one condition is associated with one or more time parameters. At block 620, the first apparatus 110 determines whether to change a mode based on the at least one condition.

In some embodiments, the one or more time parameters may comprise at least one of the following: a first time period indicating a minimum period between a first entry into a mode and a second entry into the same mode, or a second time period indicating a minimum period between a first exit from a mode and a second exit from the same mode, or a time interval indicating a minimum interval between an entry into a first mode and an entry into a second mode.

In some embodiments, the time period may be associated with an entry condition of the at least one condition, or the time period may be associated with an exit condition of the at least one condition. In some embodiments, the time period may be associated with an entry condition and an exit condition of the at least one condition.

In some embodiments, the one or more time parameters may be predefined and/or received from the second apparatus. In some embodiments, the one or more time parameters may be received via at least one of a system information (block) or a dedicated radio resource control (RRC) message.

In some embodiments, the at least one condition may comprise multiple conditions, and at least one of the following: a time parameter of the one or more time parameters may be used for the multiple conditions, or a time parameter of the one or more time parameters may be used for a condition of the multiple conditions.

In some embodiments, the at least one condition may indicate that the one or more time parameters associated with the at least one condition have elapsed. In some embodiments, determining whether to change a mode based on the at least one condition may comprise: determining not to change the mode based on determining that the one or more time parameters does not elapse, and determining to change the mode based on determining that the one or more time parameters have elapsed.

In some embodiments, the monitoring and measurement modes may comprise at least one of the following: a normal mode without using or monitoring LP-WUS, a LP-WUS monitoring mode, a serving cell measurement offloading to a LP wake up receiver (LR) mode, or a relaxed measurement mode.

In some embodiments, the configuration information may be received via at least one of a system information block or an RRC message. In some embodiments, the first apparatus 110 may be a UE, or the first apparatus 110 may be comprised in a UE, and the second apparatus 120 may comprise a network device.

FIG. 7 shows a flowchart of an example method 700 implemented at a second apparatus in accordance with some embodiments of the present disclosure. For the purpose of discussion, the method 700 will be described from the perspective of the second apparatus 120 with reference to FIG. 1A.

At block 710, the second apparatus 120 determines, for a low power (LP) wake up signal (LP-WUS) capable user equipment (UE), configuration information indicating at least one condition for monitoring and/or measurement modes, wherein the at least one condition is associated with one or more time parameters. At block 720, the second apparatus 120 transmits the configuration information.

In some embodiments, the one or more time parameters may comprise at least one of the following: a first time period indicating a minimum period between a first entry into a mode and a second entry into the same mode, or a second time period indicating a minimum period between a first exit from a mode and a second exit from the same mode, or a time interval indicating a minimum interval between an entry into a first mode and an entry into a second mode.

In some embodiments, at least one of the following: the time period may be associated with an entry condition of the at least one condition, or the time period may be associated with an exit condition of the at least one condition, or the time period may be associated with an entry condition and an exit condition of the at least one condition.

In some embodiments, the second apparatus may further transmit the one or more time parameters. In some embodiments, the one or more time parameters may be transmitted via at least one of a system information (block) or a dedicated radio resource control (RRC) message.

In some embodiments, the at least one condition may comprise multiple conditions, and at least one of the following: a time parameter of the one or more time parameters is used for the multiple conditions, or a time parameter of the one or more time parameters is used for a condition of the multiple conditions.

In some embodiments, the at least one condition may indicate that the one or more time parameters associated with the at least one condition have elapsed. In some embodiments, the monitoring and measurement modes may comprise at least one of the following: a normal mode without using or monitoring LP-WUS, a LP-WUS monitoring mode, a serving cell measurement offloading mode to a LP wake up receiver (LR), or a relaxed measurement mode.

In some embodiments, the configuration information may be transmitted via at least one of a system information block or an RRC message. In some embodiments, the first apparatus may be a UE, or the first apparatus may be comprised in a UE, and the second apparatus may comprise a network device.

FIG. 8 shows a flowchart of an example method 800 implemented at a first apparatus in accordance with some embodiments of the present disclosure. For the purpose of discussion, the method 700 will be described from the perspective of the first apparatus 110 with reference to FIG. 1A.

At block 810, the first apparatus 110 receives, from a second apparatus, configuration information indicating at least one condition for monitoring and measurement modes for a low power (LP) wake up signal (LP-WUS) capable user equipment (UE), wherein the at least one condition is associated with one or more time parameters. At block 820, the first apparatus 110 determines to change a mode based on determining at least one of (i) the at least one condition or (ii) at least one criterion of the first apparatus is satisfied.

In some embodiments, the one or more time parameters may comprise at least one of the following: a first time period indicating a minimum period between a first entry into a mode and a second entry into the same mode, or a second time period indicating a minimum period between a first exit from a mode and a second exit from the same mode, or a time interval indicating a minimum interval between an entry into a first mode and an entry into a second mode.

In some embodiments, the at least one condition may indicate that one or more time values indicated by the one or more time parameters have elapsed. In some embodiments, the monitoring and measurement modes may comprise at least one of the following: a normal mode without using or monitoring the LP-WUS, a LP-WUS monitoring mode, a serving cell measurement offloading to a LP wake up receiver (LR) mode, or a relaxed measurement mode.

In some embodiments, determining to change the mode may comprise: determining that the at least one condition for entering the LP-WUS monitoring mode is not satisfied based on determining that the one or more time parameters have not elapsed, and starting the LP-WUS monitoring mode in accordance with determining that the at least one criterion of the first apparatus is satisfied based on at least one of the following: determining that the first apparatus enters an inactive mode or an idle mode, receiving, from the second apparatus, a criterion for LP-WUS based measurements, or determining that an entry threshold for the LP-WUS monitoring mode is satisfied.

In some embodiments, determining to change the mode may comprise: determining that the at least one condition for entering the relaxed measurement mode is not satisfied based on determining that the one or more time parameters have not elapsed, and starting the relaxed measurement mode in accordance with determining that the at least one criterion of the first apparatus is satisfied based on at least one of the following: receiving, from the second apparatus, a criterion for LP-WUS based measurements, or determining that at least one entry threshold for the relaxed measurement mode is fully satisfied or partially satisfied.

In some embodiments, determining to change the mode may comprise: determining that the at least one condition for entering the serving cell measurement offloading to the LR is not satisfied based on determining that the one or more time parameters have not elapsed, and starting the serving cell measurement offloading to the LR mode in accordance with determining that the at least one criterion of the first apparatus is satisfied based on at least one of the following: determining that a criterion for serving cell measurement relaxation is satisfied, determining that at least one entry threshold for fully offloading serving cell measurement to LP-WUS is satisfied, or determining that the first apparatus consumes less energy compared to main radio (MR) based measurements and the first apparatus needs to conserve energy.

In some embodiments, at least one of the following: the time period may be associated with an entry condition of the at least one condition, or the time period may be associated with an exit condition of the at least one condition, or the time period may be associated with an entry condition and an exit condition of the at least one condition.

In some embodiments, the one or more time parameters may be predefined and/or received from the second apparatus. In some embodiments, the one or more time parameters may be received via at least one of a system information (block) or a dedicated radio resource control (RRC) message.

In some embodiments, the at least one condition may comprise multiple conditions, and at least one of the following: a time parameter of the one or more time parameters is used for the multiple conditions, or a time parameter of the one or more time parameters is used for a condition of the multiple conditions.

In some embodiments, the configuration information may be received via at least one of a system information (block) or a dedicated RRC message. In some embodiments, the first apparatus may be a UE, or the first apparatus may be comprised in a UE, and the second apparatus comprises a network device.

In some embodiments, an apparatus capable of performing any of the method 600 (for example, the first apparatus 110) is provided. The apparatus may comprise means for performing the respective steps of the method 600. The means may be implemented in any suitable form. For example, the means may be implemented in a circuitry or software module.

In some embodiments, the apparatus comprises means for receiving, at a first apparatus and from a second apparatus, configuration information indicating at least one condition for monitoring and/or measurement modes for a low power (LP) wake up signal (LP-WUS) capable user equipment (UE), wherein the at least one condition is associated with one or more time parameters, and means for determining whether to change a mode based on the at least one condition.

In some embodiments, the one or more time parameters may comprise at least one of the following: a first time period indicating a minimum period between a first entry into a mode and a second entry into the same mode, or a second time period indicating a minimum period between a first exit from a mode and a second exit from the same mode, or a time interval indicating a minimum interval between an entry into a first mode and an entry into a second mode.

In some embodiments, at least one of the following: the time period may be associated with an entry condition of the at least one condition, or the time period may be associated with an exit condition of the at least one condition; or the time period may be associated with an entry condition and an exit condition of the at least one condition.

In some embodiments, the one or more time parameters may be predefined and/or received from the second apparatus. In some embodiments, the one or more time parameters may be received via at least one of a system information (block) or a dedicated radio resource control (RRC) message.

In some embodiments, the at least one condition may comprise multiple conditions, and at least one of the following: a time parameter of the one or more time parameters is used for the multiple conditions, or a time parameter of the one or more time parameters is used for a condition of the multiple conditions.

In some embodiments, the at least one condition may indicate that the one or more time parameters associated with the at least one condition have elapsed.

In some embodiments, means for determining whether to change a mode based on the at least one condition may comprise means for determining not to change the mode based on determining that the one or more time parameters does not elapse, and determining to change the mode based on determining that the one or more time parameters have elapsed.

In some embodiments, the monitoring and measurement modes may comprise at least one of the following: a normal mode without using or monitoring LP-WUS, a LP-WUS monitoring mode, a serving cell measurement offloading to a LP wake up receiver (LR) mode, or a relaxed measurement mode.

In some embodiments, the configuration information may be received via at least one of a system information block or an RRC message. In some embodiments, the first apparatus may be a UE, or wherein the first apparatus may be comprised in a UE, and the second apparatus may comprise a network device.

In some embodiments, the apparatus may further comprise means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, an apparatus capable of performing any of the method 700 (for example, the second apparatus 120) is provided. The apparatus may comprise means for performing the respective steps of the method 700. The means may be implemented in any suitable form. For example, the means may be implemented in a circuitry or software module.

In some embodiments, the apparatus comprises means for determining, at a second apparatus and for a low power (LP) wake up signal (LP-WUS) capable user equipment (UE), configuration information indicating at least one condition for monitoring and/or measurement modes, wherein the at least one condition is associated with one or more time parameters, and means for transmitting the configuration information.

In some embodiments, the one or more time parameters may comprise at least one of the following: a first time period indicating a minimum period between a first entry into a mode and a second entry into the same mode, or a second time period indicating a minimum period between a first exit from a mode and a second exit from the same mode, or a time interval indicating a minimum interval between an entry into a first mode and an entry into a second mode.

In some embodiments, at least one of the following: the time period may be associated with an entry condition of the at least one condition, or the time period may be associated with an exit condition of the at least one condition, or the time period may be associated with an entry condition and an exit condition of the at least one condition.

In some embodiments, the apparatus may further comprise means for transmitting the one or more time parameters. In some embodiments, the one or more time parameters may be transmitted via at least one of a system information (block) or a dedicated radio resource control (RRC) message.

In some embodiments, the at least one condition may comprise multiple conditions, and at least one of the following: a time parameter of the one or more time parameters is used for the multiple conditions, or a time parameter of the one or more time parameters is used for a condition of the multiple conditions.

In some embodiments, the at least one condition may indicate that the one or more time parameters associated with the at least one condition have elapsed. In some embodiments, the monitoring and measurement modes may comprise at least one of the following: a normal mode without using or monitoring LP-WUS, a LP-WUS monitoring mode, a serving cell measurement offloading mode to a LP wake up receiver (LR), or a relaxed measurement mode.

In some embodiments, the configuration information may be transmitted via at least one of a system information block or an RRC message. In some embodiments, the first apparatus may be a UE, or wherein the first apparatus may be comprised in a UE, and the second apparatus may comprise a network device.

In some embodiments, the apparatus may further comprise means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the first apparatus 110) is provided. The apparatus may comprise means for performing the respective steps of the method 800. The means may be implemented in any suitable form. For example, the means may be implemented in a circuitry or software module.

In some embodiments, the apparatus comprises means for receiving, from a second apparatus, configuration information indicating at least one condition for monitoring and measurement modes for a low power (LP) wake up signal (LP-WUS) capable user equipment (UE), wherein the at least one condition is associated with one or more time parameters, and means for determining to change a mode based on determining at least one of (i) the at least one condition or (ii) at least one criterion of the first apparatus is satisfied.

In some embodiments, the one or more time parameters may comprise at least one of the following: a first time period indicating a minimum period between a first entry into a mode and a second entry into the same mode, or a second time period indicating a minimum period between a first exit from a mode and a second exit from the same mode, or a time interval indicating a minimum interval between an entry into a first mode and an entry into a second mode.

In some embodiments, the at least one condition may indicate that one or more time values indicated by the one or more time parameters have elapsed. In some embodiments, the monitoring and measurement modes may comprise at least one of the following: a normal mode without using or monitoring the LP-WUS, a LP-WUS monitoring mode, a serving cell measurement offloading to a LP wake up receiver (LR) mode, or a relaxed measurement mode.

In some embodiments, the means for determining to change the mode may comprise means for determining that the at least one condition for entering the LP-WUS monitoring mode is not satisfied based on determining that the one or more time parameters have not elapsed, and starting the LP-WUS monitoring mode in accordance with determining that the at least one criterion of the first apparatus is satisfied based on at least one of the following: determining that the first apparatus enters an inactive mode or an idle mode, receiving, from the second apparatus, a criterion for LP-WUS based measurements, or determining that an entry threshold for the LP-WUS monitoring mode is satisfied.

In some embodiments, the means for determining to change the mode may comprise means for determining that the at least one condition for entering the relaxed measurement mode is not satisfied based on determining that the one or more time parameters have not elapsed, and starting the relaxed measurement mode in accordance with determining that the at least one criterion of the first apparatus is satisfied based on at least one of the following: receiving, from the second apparatus, a criterion for LP-WUS based measurements, or determining that at least one entry threshold for the relaxed measurement mode is fully satisfied or partially satisfied.

In some embodiments, means for determining to change the mode may comprise means for determining that the at least one condition for entering the serving cell measurement offloading to the LR is not satisfied based on determining that the one or more time parameters have not elapsed, and starting the serving cell measurement offloading to the LR mode in accordance with determining that the at least one criterion of the first apparatus is satisfied based on at least one of the following: determining that a criterion for serving cell measurement relaxation is satisfied, determining that at least one entry threshold for fully offloading serving cell measurement to LP-WUS is satisfied, or determining that the first apparatus consumes less energy compared to main radio (MR) based measurements and the first apparatus needs to conserve energy.

In some embodiments, at least one of the following: the time period may be associated with an entry condition of the at least one condition, or the time period may be associated with an exit condition of the at least one condition, or the time period may be associated with an entry condition and an exit condition of the at least one condition.

In some embodiments, the one or more time parameters may be predefined and/or received from the second apparatus. In some embodiments, the one or more time parameters may be received via at least one of a system information (block) or a dedicated radio resource control (RRC) message.

In some embodiments, the at least one condition may comprise multiple conditions, and at least one of the following: a time parameter of the one or more time parameters is used for the multiple conditions, or a time parameter of the one or more time parameters is used for a condition of the multiple conditions.

In some embodiments, the configuration information may be received via at least one of a system information (block) or a dedicated RRC message. In some embodiments, the first apparatus may be a UE, or wherein the first apparatus is comprised in a UE, and the second apparatus comprises a network device.

In some embodiments, the apparatus may further comprise means for performing other steps in some embodiments of the method 800. In some embodiments, the means comprises at least one processor and at least one memory including computer program code, the at least one memory and computer program code configured to, with the at least one processor, cause the performance of the apparatus.

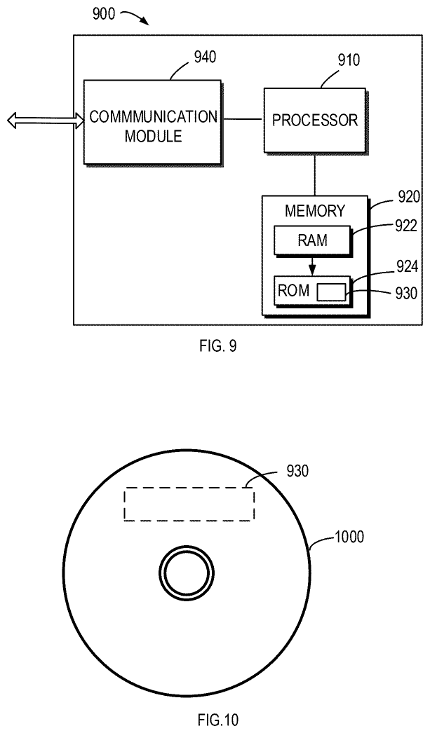

FIG. 9 is a simplified block diagram of a device 900 that is suitable for implementing embodiments of the present disclosure. The device 900 may be provided to implement the communication device, for example the terminal device 110 or the network device 120 as shown in FIG. 1A. As shown, the device 900 includes one or more processors 910, one or more memories 920 coupled to the processor 910, and one or more communication modules 940 coupled to the processor 910.

The communication modules 940 are for bidirectional communications. The communication modules 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a read only memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of example embodiments of the disclosure as discussed with reference to FIGS. 2 to 5. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Example embodiments of the present disclosure also provide at least one computer program product tangibly stored on a non-transitory computer readable storage medium. The computer program product includes computer-executable instructions, such as those included in program modules, being executed in a device on a target real or virtual processor, to carry out the methods 600, 700 and 800 as described above with reference to FIGS. 6-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of example embodiments of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although example embodiments of the present disclosure have been described in languages specific to structural features and/or methodological acts, it is to be understood that the example embodiments of the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, configuration information indicating at least one condition for monitoring and measurement modes for a low power (LP) wake up signal (LP-WUS) capable user equipment (UE), wherein the at least one condition is associated with one or more time parameters; and
determine to change a mode based on determining at least one of (i) the at least one condition or (ii) at least one criterion of the first apparatus is satisfied.

2. The first apparatus of claim 1, wherein the one or more time parameters comprise at least one of the following:
a first time period indicating a minimum period between a first entry into a mode and a second entry into the same mode; or
a second time period indicating a minimum period between a first exit from a mode and a second exit from the same mode; or
a time interval indicating a minimum interval between an entry into a first mode and an entry into a second mode.

3. The first apparatus of claim 1, wherein the at least one condition indicates that one or more time values indicated by the one or more time parameters have elapsed.

4. The first apparatus of claim 1, wherein the monitoring and measurement modes comprise at least one of the following:
a normal mode without using or monitoring the LP-WUS;
a LP-WUS monitoring mode;
a serving cell measurement offloading to a LP wake up receiver (LR) mode; or
a relaxed measurement mode.

5. The first apparatus of claim 1, wherein the first apparatus is caused to determine to change the mode by:
determining that the at least one condition for entering the LP-WUS monitoring mode is not satisfied based on determining that the one or more time parameters have not elapsed; and
starting the LP-WUS monitoring mode in accordance with determining that the at least one criterion of the first apparatus is satisfied based on at least one of the following:
determining that the first apparatus enters an inactive mode or an idle mode;
receiving, from the second apparatus, a criterion for LP-WUS based measurements; or
determining that an entry threshold for the LP-WUS monitoring mode is satisfied.

6. The first apparatus of claim 1, wherein the first apparatus is caused to determine to change the mode by:
determining that the at least one condition for entering the relaxed measurement mode is not satisfied based on determining that the one or more time parameters have not elapsed; and
starting the relaxed measurement mode in accordance with determining that the at least one criterion of the first apparatus is satisfied based on at least one of the following:
receiving, from the second apparatus, a criterion for LP-WUS based measurements; or
determining that at least one entry threshold for the relaxed measurement mode is fully satisfied or partially satisfied.

7. The first apparatus of claim 1, wherein the first apparatus is caused to determine to change the mode by:
determining that the at least one condition for entering the serving cell measurement offloading to the LR is not satisfied based on determining that the one or more time parameters have not elapsed; and
starting the serving cell measurement offloading to the LR mode in accordance with determining that the at least one criterion of the first apparatus is satisfied based on at least one of the following:
determining that a criterion for serving cell measurement relaxation is satisfied;
determining that at least one entry threshold for fully offloading serving cell measurement to LP-WUS is satisfied; or
determining that the first apparatus consumes less energy compared to main radio (MR) based measurements and the first apparatus needs to conserve energy.

8. The first apparatus of claim 2, wherein at least one of the following:
the time period is associated with an entry condition of the at least one condition; or
the time period is associated with an exit condition of the at least one condition; or
the time period is associated with an entry condition and an exit condition of the at least one condition.

9. The first apparatus of claim 1, wherein the one or more time parameters are predefined and/or received from the second apparatus.

10. The first apparatus of claim 9, wherein the one or more time parameters are received via at least one of a system information (block) or a dedicated radio resource control (RRC) message.

11. The first apparatus of claim 1, wherein the at least one condition comprises multiple conditions, and at least one of the following:
a time parameter of the one or more time parameters is used for the multiple conditions; or
a time parameter of the one or more time parameters is used for a condition of the multiple conditions.

12. The first apparatus of claim 1, wherein the configuration information is received via at least one of a system information (block) or a dedicated RRC message.

13. The first apparatus of claim 1, wherein the first apparatus is a UE, or wherein the first apparatus is comprised in a UE, and the second apparatus comprises a network device.

14. A method comprising:
receiving, at a first apparatus and from a second apparatus, configuration information indicating at least one condition for monitoring and measurement modes for a low power (LP) wake up signal (LP-WUS) capable user equipment (UE), wherein the at least one condition is associated with one or more time parameters; and
determining whether to change a mode based on determining at least one of (i) the at least one condition or (ii) at least one criterion of the first apparatus is satisfied.

15. The method of claim 14, wherein the one or more time parameters comprise at least one of the following:
a first time period indicating a minimum period between a first entry into a mode and a second entry into the same mode; or
a second time period indicating a minimum period between a first exit from a mode and a second exit from the same mode; or
a time interval indicating a minimum interval between an entry into a first mode and an entry into a second mode.

16. The method of claim 14, wherein the at least one condition indicates that one or more time values indicated by the one or more time parameters have elapsed.

17. The method of claim 14, wherein the monitoring and measurement modes comprise at least one of the following:
a normal mode without using or monitoring the LP-WUS;
a LP-WUS monitoring mode;
a serving cell measurement offloading to a LP wake up receiver (LR) mode; or
a relaxed measurement mode.

18. The method of claim 14, wherein determining whether to change the mode comprises:
determining that the at least one condition for entering the LP-WUS monitoring mode is not satisfied based on determining that the one or more time parameters have not elapsed; and
starting the LP-WUS monitoring mode in accordance with determining that the at least one criterion of the first apparatus is satisfied based on at least one of the following:
determining that the first apparatus enters an inactive mode or an idle mode;
receiving, from the second apparatus, a criterion for LP-WUS based measurements; or
determining that an entry threshold for the LP-WUS monitoring mode is satisfied.

19. The method of claim 14, wherein determining whether to change the mode comprises:
determining that the at least one condition for entering the relaxed measurement mode is not satisfied based on determining that the one or more time parameters have not elapsed; and
starting the relaxed measurement mode in accordance with determining that the at least one condition criterion of the first apparatus is satisfied based on at least one of the following:
receiving, from the second apparatus, a criterion for LP-WUS based measurements; or
determining that at least one entry threshold for the relaxed measurement mode is fully satisfied or partially satisfied.

20. The method of claim 14, wherein determining whether to change the mode comprises:
determining that the at least one condition for entering the serving cell measurement offloading to the LR is not satisfied based on determining that the one or more time parameters have not elapsed; and
starting a serving cell measurement offloading to the LR mode in accordance with determining that the at least one criterion of the first apparatus is satisfied based on at least one of the following:
determining that a criterion for serving cell measurement relaxation is satisfied;
determining that at least one entry threshold for fully offloading serving cell measurement to LP-WUS is satisfied; or
determining that the first apparatus consumes less energy compared to main radio (MR) based measurements and the first apparatus needs to conserve energy.
